(19) United States
(12) Patent Application Publication
(10) Pub. No.: US 2025/0079632 A1
(43) Pub. Date: Mar. 6, 2025

(54) SEPARATOR FOR LITHIUM SECONDARY BATTERY AND LITHIUM SECONDARY BATTERY COMPRISING SAME

(71) Applicant: SAMSUNG SDI CO., LTD., Gyeonggi-do (KR)

(72) Inventors: Jinyoung KIM, Gyeonggi-do (KR); Hyeonseon CHOI, Gyeonggi-do (KR); Dongwan SEO, Gyeonggi-do (KR)

(73) Assignee: SAMSUNG SDI CO., LTD., Gyeonggi-do (KR)

(21) Appl. No.: 18/844,186

(22) PCT Filed: Feb. 20, 2023
(86) PCT No.: PCT/KR2023/002404

§ 371 Date: Sep. 5, 2024

(30) Foreign Application Priority Data
Apr. 15, 2022 (KR) 10-2022-0047166

(51) Int. Cl. H01M 50/446; H01M 10/052; H01M 50/417; H01M 50/434; H01M 50/443; H01M 50/491

(52) U.S. Cl. CPC H01M 50/446; H01M 10/052; H01M 50/417; H01M 50/434; H01M 50/443; H01M 50/491

(57) ABSTRACT

Provided are a separator for a lithium secondary battery and a lithium secondary battery comprising same. The separator for a lithium secondary battery includes a porous substrate and a coating layer positioned on at least one surface of the porous substrate and including polyethylene particles, inorganic particles, and a binding binder, wherein the inorganic particles are a mixture of first inorganic particles and second inorganic particles, the second inorganic particles are plate-shaped Mg(OH)₂, the mixing ratio of the polyethylene particles and the inorganic particles is 5:5 to 8:2 by weight, and the mixing ratio of the first inorganic particles and the second inorganic particles is 1:9 to 3:7 by weight.

### TECHNICAL FIELD

A separator for a lithium secondary battery and a lithium secondary battery including the same are disclosed.

### BACKGROUND ART

Lithium secondary batteries have a high discharge voltage and high energy density, and are attracting attention as a power source for various electronic devices.

A lithium secondary battery is arranged so that the positive and negative electrodes may face each other, has a structure filled with an electrolyte solution, and a separator is located between the positive and negative electrodes to prevent short circuit. The separator may be a porous material that may transfer ions or electrolytes.

If a battery is exposed to a high temperature environment due to abnormal behavior, a separator may mechanically shrink or be damaged due to melting characteristics at a low temperature. Herein, the positive and negative electrodes contact each other and may cause an explosion of the battery. In order to solve the problems, technology is needed to suppress shrinkage of the separator and ensure the safety of the battery.

### Technical Problem

An embodiment is to provide a separator for a lithium secondary battery with excellent safety.

Another embodiment provides a lithium secondary battery including the separator.

### TECHNICAL SOLUTION

According to an embodiment, a separator for a lithium secondary battery includes a porous substrate; and a coating layer positioned on at least one surface of the porous substrate and including polyethylene particles, inorganic particles, and a binding binder, wherein the inorganic particles are a mixture of first inorganic particles and second inorganic particles, the second inorganic particles are plate-shaped Mg(OH)₂, a mixing ratio of the polyethylene particles and the inorganic particles is 5:5 to 8:2 by weight ratio, and an amount of the second inorganic particles is greater than an amount of the first inorganic particles.

A mixing ratio of the first inorganic particles and the second inorganic particles may be a weight ratio of 1:9 to 3:7.

The first inorganic particles may include Al₂O₃, SiO₂, TiO₂, SnO₂, CeO₂, MgO, NiO, CaO, GaO, ZnO, ZrO₂, Y₂O₃, SrTiO₃, BaTiO₃, boehmite, or a combination thereof.

The separator may further include an adhesive layer formed on one surface of the coating layer.

The adhesive layer may include a binder and a filler.

An amount of the binding binder may be greater than or equal to 1 wt % and less than 6.5 wt % based on total 100 wt % of the coating layer.

The coating layer may further include a curable binder. If the coating layer further includes a curable binder, a total amount of the binding binder and the curable binder included in the coating layer may be greater than or equal to 5 wt %, 5 wt to 8 wt %, 5 wt % to 7 wt %, 5 wt % to 6.5 wt % based on total 100 wt % of the coating layer.

In an embodiment, a mixing ratio of the binding binder and the curable binder may be a weight ratio of 1:9 to 9:1.

An amount of the second inorganic particles may be 20 wt % to 50 wt % based on total 100 wt % of the coating layer.

Additionally, an amount of the inorganic particles may be 25 wt % to 55 wt % based on total 100 wt % of the coating layer.

The binding binder may be an aqueous binder.

According to another embodiment, a lithium secondary battery includes a negative electrode including a negative electrode active material; a positive electrode including a positive electrode active material; a separator located between the negative electrode and the positive electrode; and a non-aqueous electrolyte.

Details of other embodiments are included in the detailed description below.

### Advantageous Effects

A separator for a lithium secondary battery according to an embodiment may exhibit excellent safety.

### BRIEF DESCRIPTION OF THE DRAWINGS

FIG. 1 is a view briefly showing a lithium secondary battery according to an embodiment.

### BEST MODE FOR PERFORMING INVENTION

Hereinafter, embodiments of the present invention are described in detail. However, these embodiments are exemplary, the present invention is not limited thereto and the present invention is defined by the scope of claims. The terminology used herein is used to describe embodiments only, and is not intended to limit the present disclosure. The singular expression includes the plural expression unless the context clearly dictates otherwise.

“Combination thereof” means a mixture, laminate, composite, copolymer, alloy, blend, reaction product, and the like of the constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

“Thickness” may be measured through a photograph taken with an optical microscope such as a scanning electron microscope.

The average size may refer to an average particle diameter (D50), and in the present specification, when a definition is not otherwise provided, an average particle diameter (D50) indicates a particle where a cumulative volume is 50 volume % in a particle distribution.

The average particle size (D50) may be measured by a method well known to those skilled in the art, for example, by a particle size analyzer, a transmission electron microscope image, or a scanning electron microscope image. Alternatively, a dynamic light-scattering measurement device is used to perform a data analysis, and the number of particles is counted for each particle size range, and from this, the average particle diameter (D50) value may be easily obtained through a calculation.

A separator according to an embodiment includes a porous substrate and a coating layer located on at least one surface of the porous substrate and including polyethylene particles, inorganic particles, and a binding binder. At this time, the inorganic particles are a mixture of first inorganic particles and second inorganic particles, and the second inorganic particles may be plate-shaped Mg(OH)₂.

That is, the separator according to an embodiment essentially includes plate-shaped Mg(OH)₂ in the coating layer. In this way, if the coating layer includes plate-shaped Mg(OH)₂, penetration may be effectively suppressed during penetration testing, thereby improving safety. This effect may not be obtained even if it includes Mg(OH)₂, if it includes Mg(OH) 2 in the form of particles rather than the form of plates. Additionally, if ceramics other than Mg(OH)₂ are plate-shaped, the effect of improving safety is minimal. This is because an endothermic amount of Mg(OH)₂ (endothermic peak temperature: about 430.7° C., enthalpy 1119 J/g) is higher than that of other ceramics, such as Al₂O₃ (endothermic peak temperature: about 335.2° C., enthalpy 1033 J/g), improving the safety improvement effect.

The first inorganic particles may be Al₂O₃, SiO₂, TiO₂, SnO₂, CeO₂, MgO, NiO, CaO, GaO, ZnO, ZrO₂, Y₂O₃, SrTiO₃, BaTiO₃, boehmite, or a combination thereof.

In an embodiment, a mixing ratio of the polyethylene particles and the inorganic particles may be a weight ratio of 5:5 to 8:2, or 6:4 to 8:2.

Additionally, an amount of the second inorganic particles in the coating layer may be greater than the first inorganic particles, that is, the second inorganic particles may be in excess of the first inorganic particles. For example, a mixing ratio of the first inorganic particles and the second inorganic particles may be a weight ratio of 1:9 to 3:7.

If the mixing ratio of polyethylene particles and inorganic particles is within the above range, safety and air permeability characteristics may be further improved, and the resistance reduction effect may be increased. In an embodiment, the polyethylene does not melt during normal charging and discharging within the battery, but if a high temperature phenomenon occurs within the battery, it melts before the porous substrate at the melting temperature or more and block the pores within the porous substrate to block the movement of ions, induces a quick shutdown function, and ensures the safety of the secondary battery. To explain this in more detail, the melting temperature of polyethylene is 100° C. to 120° C., which is approximately 30° C. lower than the melting temperature of the porous substrate, and thus if a high temperature phenomenon occurs in the battery, it may melt before the porous substrate.

If the amount of polyethylene particles is less than the above range, the pores of the porous substrate due to melting of polyethylene are not sufficiently blocked, and safety may not be ensured during penetration, which is not appropriate. In addition, if the amount of polyethylene particles is excessive than the above range, the coating layer may not be properly coated on the porous substrate, the air permeability value increases excessively, and resistance increases, which is not appropriate.

Additionally, if the second inorganic particles are in excess of the first inorganic particles, specifically, if the mixing ratio of the first inorganic particles and the second inorganic particles is within the above range, excellent safety may be exhibited. If the amount of the first inorganic particle exceeds the above range, safety may be significantly deteriorated, such as ignition occurring during penetration.

The amount of the second inorganic particles may be 20 wt % to 50 wt %, 20 wt % to 38 wt %, 20 wt % to 35 wt % based on total 100 wt % of the coating layer. If the amount of the second inorganic particles is within the above range, safety may be greatly improved.

Additionally, the amount of the inorganic particles may be 25 wt % to 55 wt %, or 30 wt % to 55 wt % based on total 100 wt % of the coating layer. If the amount of the inorganic particles, that is, the total amount of the first and second inorganic particles, is within the above range, the effects of high heat absorption and improved safety may be well obtained without increasing resistance.

An average size of the first inorganic particles may be 550 nm to 750 nm, 600 nm to 750 nm, or 600 nm to 700 nm.

In an embodiment, the shape of the first inorganic particle may be cubic-shaped, plate-shaped, spherical-shaped, or unspecific-shaped, and the shape does not need to be limited.

The second inorganic particles are plate-shaped, and the average thickness thereof may be 0.1 μm to 0.5 μm, 0.2 μm to 0.5 μm, or 0.2 μm to 0.3 μm.

If the average size and average thickness of the second inorganic particles are within the above ranges, the safety effect of the plate-shape may be obtained more effectively without acting as resistance, and appropriate air permeability and binding power to the porous substrate are improved, increasing cycle life characteristics.

The average size of the second inorganic particles may be 0.1 μm to 2 μm, 0.2 μm to 1.5 μm, 0.2 μm to 1.0 μm, or 0.5 μm to 1.0 μm. If the average size of the second inorganic particles is within the above range, more appropriate air permeability (resistance) and safety effects may be exhibited.

In an embodiment, the polyethylene particles may be in a wax form. At this time, the wax form, that is, polyethylene wax, means that the molecular weight is larger than that of an oligomer and smaller than that of a polymer, and for example, the weight average molecular weight (Mw) may be 1000 g/mol to 5000 g/mol. If the weight average molecular weight of the polyethylene particles is within this range, it may have an appropriate melting temperature, for example, 100° C. to 120° C., thereby inducing a shutdown function at the required temperature and exhibiting an appropriate shutdown effect.

The average size of the polyethylene particles may be 0.1 μm to 3.0 μm. Specifically, the average size of the polyethylene particles may be 0.1 μm to 2.0 μm, 0.5 μm to 2.0 μm, e.g., 0.5 μm to 1.5 μm, 1.0 μm to 1.5 μm, 1.0 μm to 1.4 μm, or 1.1 μm to 1.3 μm. If the average size of polyethylene particles is within the above range, pores existing in the porous substrate may be blocked more effectively if a high temperature phenomenon occurs.

The binding binder included in the coating layer may be an aqueous binder. The aqueous binder may be, e.g., a styrene-butadiene rubber, an acrylated styrene-butadiene rubber, polyvinyl alcohol, sodium polyacrylate, a copolymer of propylene and a C2 to C8 olefin, poly acrylamide, a copolymer of (meth)acrylic acid and (meth)acrylic acid alkyl ester, or a combination thereof.

An amount of the binding binder may be greater than or equal to 1 wt % and less than 6.5 wt %, 1.0 wt % to 5 wt %, 1.0 wt % to 4.5 wt %, 11 wt % to 4.4 wt %, or 2.0 wt % to 4.4 wt % based on 100 wt % of the coating layer. If the amount of the binding binder is within the above range, excellent adhesion between the porous substrate and the coating layer may be exhibited while maintaining appropriate resistance.

The coating layer may further include a curable binder.

The separator may further include an adhesive layer on one surface of the coating layer. As the separator further includes an adhesive layer, deformation of the battery that may occur during battery charging and discharging may be prevented more effectively, thereby solving capacity reduction and safety issues more effectively. The effect of further including this adhesive layer may be obtained more effectively if the battery type is a pouch battery.

The curable binder included in the coating layer may include at least one of an acrylic copolymer and a fluorine-based binder.

The acrylic copolymer may be in the form of particles, and the fluorine-based binder may also be in the form of particles. In an embodiment, (meth)acrylic may mean acrylic or methacrylic.

The acrylic copolymer may be a (meth)acrylic copolymer, e.g., a (meth)acrylic copolymer having a core-shell structure. Specifically, it may be a (meth)acrylic polymer including a structural unit derived from (meth)acrylic acid or (meth)acrylate and a structural unit derived from a monomer including a polymerizable unsaturated group.

More specifically, the core of the (meth)acrylic adhesive binder may include a structural unit derived from (meth)acrylic acid or (meth)acrylate, and the shell of the (meth)acrylic adhesive binder may include a structural unit derived from a monomer including a polymerizable unsaturated group.

The monomer including the polymerizable unsaturated group included in the shell of the (meth)acrylic adhesive binder may be at least one selected from a styrene-based monomer, an acid-derived monomer, and a combination thereof.

Specifically, the styrene-based monomer may include at least one aromatic vinyl monomer represented by Chemical Formula 10.

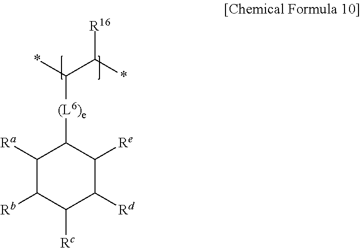

In Chemical Formula 10,
R¹⁶ is hydrogen or a C1 to C6 alkyl group,
R^{a} to R^{e} are independently hydrogen or a C1 to C6 alkyl group,
L⁶ is a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
e is one of the integers from 0 to 2, and
* is a linking point.

More specifically, the styrene-based monomer may be at least one selected from methyl styrene, bromo styrene, chloro styrene, and a combination thereof as well as styrene.

More specifically, the acid-derived monomer may include a substituent corresponding to —COOH and may be at least one selected from itaconic acid, (meth)acrylic acid, and a combination thereof.

For example, the acrylic copolymer may be an acrylic copolymer including a repeating unit derived from a (meth)acrylate-based monomer. In addition, the acrylic copolymer may further include repeating units derived from an acetate group-containing monomer in addition to repeating units derived from the (meth)acrylate-based monomer.

The usable acrylic copolymer including a repeating unit derived from the (meth)acrylate-based monomer and/or a repeating unit derived from the acetate group-including monomer are not particularly limited as long as they may form good adhesion at the pressing temperature between the positive electrode and negative electrode, but the acrylic copolymer may be for example a copolymer produced by polymerizing one or more (meth)acrylate-based monomers selected from butyl (meth)acrylate, propyl (meth)acrylate, ethyl (meth)acrylate, and methyl (meth)acrylate. Alternatively, the acrylic copolymer may be a copolymer produced by polymerizing one or more (meth)acrylate-based monomers selected from butyl (meth)acrylate, propyl (meth)acrylate, ethyl (meth)acrylate, and methyl (meth)acrylate, and one or more acetate group-containing monomers selected from vinyl acetate and allyl acetate.

The repeating unit derived from the acetate group-containing monomer may be the repeating unit of Chemical Formula 11.

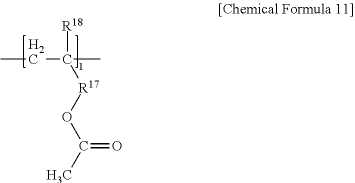

In Chemical Formula 11,
R¹ is a single bond or lineared or branched alkyl having C1 to C6, R¹⁸ is hydrogen or methyl, and I is each an integer between 1 and 100.

For example, the repeating unit derived from the acetate group-containing monomer may be a repeating unit derived from one or more acetate group-containing monomers selected from vinyl acetate and allyl acetate. The acrylic copolymer may be prepared by polymerizing (meth)acrylate-based monomers, or may be prepared by polymerizing (meth)acrylate-based monomers and other monomers other than (meth)acrylate-based monomers. For example, the other monomers may be an acetate group-containing monomer. In this case, the (meth)acrylate monomer and other monomers, specifically the acetate group-containing monomer, may be polymerized at a molar ratio of 3:7 to 7:3, specifically 4:6 to 6:4, and more specifically about 5:5. The acrylic copolymer may be prepared by a polymerization reaction, for example, of a butyl (meth)acrylate monomer, a methyl (meth)acrylate monomer, and a vinyl acetate and/or allyl acetate monomer at a molar ratio of 3 to 5:0.5 to 1.5:4 to 6, specifically at a molar ratio of 4:1:5.

The acrylic copolymers may be crosslinked or non-crosslinked. To prepare a crosslinked acrylic copolymer, a crosslinking agent may be further added during the polymerization step.

The glass transition temperature (Tg) of the acrylic copolymer may be 110° C. or less, and may be 20° C. to 110° C.

Within the above range, not only is electrode adhesion more excellent, but also better ionic conductivity may be exhibited.

A particle size of the acrylic copolymer may be 0.2 μm to 1.0 μm, specifically 0.2 μm to 0.7 μm, e.g., 0.3 μm to 0.7 μm or 0.4 μm to 0.7 μm. The particle size may be adjusted by controlling an addition amount of an initiator, an addition amount of an emulsifier, a reaction temperature, and a stirring speed.

The fluorine-based binder may specifically include a polyvinylidene fluoride (PVdF) homopolymer or a copolymer of vinylidene fluoride and another monomer.

Another monomer that may be copolymerized with the vinylidene fluoride to form a copolymer may be one or more selected from chlorotrifluoroethylene, trifluoroethylene, hexafluoropropylene, ethylene tetrafluoride, and ethylene monomer. For example, the copolymer may be a polyvinylidene fluoride-hexafluoropropylene (PVdF-HFP) copolymer including a unit derived from a vinylidene fluoride monomer and a unit derived from a hexafluoropropylene monomer.

A weight average molecular weight of the fluorine-based binder may be 100,000 g/mol to 1,500,000 g/mol, or for example, 300,000 g/mol to 800,000 g/mol. If the weight average molecular weight of the fluorine-based binder satisfies the above range, the fluorine-based adhesive binder and a separator including the same may exhibit excellent adhesion, heat resistance, air permeability, and oxidation resistance.

The weight average molecular weight may be a polystyrene-reduced average molecular weight measured using gel permeation chromatography.

A glass transition temperature (Tg) of the fluorine-based binder may be −45° C. to −35° C., for example, −42° C. to −38° C., and a melting point may be 100° C. to 180° C., for example, 130° C. to 160° C. If the glass transition temperature and melting point of the fluorine-based binder satisfy the above ranges, the fluorine-based binder and the separator including the same may exhibit excellent adhesion, heat resistance, air permeability, and oxidation resistance. The glass transition temperature may be a value measured by differential scanning calorimetry.

A particle size of the fluorine-based binder may be 100 nm to 500 nm, or for example, 150 nm to 300 nm.

The particle size may be adjusted by controlling an addition amount of an initiator, an addition amount of an emulsifier, a reaction temperature, and a stirring speed.

In an embodiment, if the coating layer further includes a curable binder, a total amount of the binding binder and the curable binder included in the coating layer may be at least 5 wt %, 5 wt % to 8 wt %, 5 wt % to 7 wt %, or 5 wt % to 6.5 wt % based on a total of 100% by weight of the coating layer. Herein, an amount of the binding binder may be greater than or equal to 20 wt % and less than or equal to 80 wt % at maximum. It may be at least 1 wt % based on total 100 wt % of the binding binder and the curing binder, and at least 2.2 wt % based on total 100 wt % of the coating layer. A maximum amount of the binding binder may be less than 6.5 wt %, less than 6 wt %, less than 5.5 wt %, less than 5 wt %, or less than or equal to 4.4 wt %, based on total 100 wt % of the coating layer.

If the amount of the binder is within the above range, in particular, if the binder of the binding binder is within the above range, better binding strength may be achieved, and thus, greater safety may be achieved. The amount of the curable binder may be at least 1 wt % based on total 100 wt % of the coating layer and may be at least 2.2 wt % based on total 100 wt % of the coating layer. A maximum amount of the curable binder may be less than 6.5 wt %, less than 6 wt %, less than 5.5 wt %, less than 5 wt %, or less than or equal to 4.4 wt %, based on total 100 wt % of the coating layer.

If the total amount of the curable binder and the binding binder is 5.5 wt % based on total 100 wt % of the coating layer, 3.3 wt % of the curable binder and 2.2 wt % of the binding binder may be used.

In addition, in the coating layer, a mixing ratio of the binding binder and the curing binder may be a weight ratio of 1:9 to 9:1, 2:8 to 8:2, or 2:8 to 4:6, or 2:8 to 5:5.

The adhesive layer may include a binder and filler.

A weight ratio of the binder and filler may be 1:1 or more and less than 1:4, e.g., 1:1.5 to 1:3.5, e.g., 1:2 to 1:3.5, or e.g., 1:2.5 to 1:3.5.

In this specification, ‘(meth)acrylic’ means acrylic or methacrylic.

The binder may be (meth)acrylic acid, (meth)acrylate, (meth)acrylonitrile, (meth)acrylamidosulfonic acid, a (meth)acrylamidosulfonate salt, styrene, ethylhexyl acrylate, a combination thereof, or a copolymer thereof.

The filler may be polyvinylidene fluoride, a polyvinylidene fluoride-hexafluoropropylene copolymer, polytetrafluoroethylene, or a combination thereof.

The porous substrate has a large number of pores and may be a substrate commonly used in batteries. The porous substrate may include any one selected from polyolefin such as polyethylene and polypropylene, polyester such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, polyethylenenaphthalate, a glass fiber, TEFLON (tetrafluoroethylene), and polytetrafluoroethylene, or a copolymer or mixture of two or more types thereof.

In an embodiment, the porous substrate may include polyolefin. The porous substrate including polyolefin may include, for example, a polyethylene single film, a polypropylene single film, a polyethylene/polypropylene double film, a polypropylene/polyethylene/polypropylene triple film, or a polyethylene/polypropylene/polyethylene triple film.

A thickness of one surface of the coating layer may be 1 μm to 5 μm, e.g., 1 μm to 5 μm, 1 μm to 4 μm, 1 μm to 3 μm, or 1 μm to 2 μm. The coating layer may be formed on only one surface or on both surfaces of the porous substrate, and the thickness is a thickness of one surface, and thus if formed on both surfaces, it may be 1 μm to 10 μm, 2 μm to 10 μm, 2 μm to 8 μm, 2 μm to 6 μm, or 2 μm to 4 μm. If the thickness of the coating layer is within the above range, better safety may be achieved, and battery characteristics such as excellent cycle-life characteristics may be improved more effectively without increasing resistance.

A thickness of one surface of the adhesive layer may be 0.1 μm to 4.0 μm, for example, 0.1 μm to 3.0 μm, 0.1 μm to 2.0 μm, 0.1 to 1 μm, 0.3 μm to 1.0 μm, or 0.5 μm to 1.0 μm. If the thickness of the adhesive layer is within the above range, more sufficient adhesive strength may be achieved, a stable battery structure may be maintained during formation charging and discharging and repeated charging and discharging, and appropriate battery characteristics C may be realized without increasing resistance.

The porous substrate may have a thickness of 1 μm to 40 μm, for example 1 μm to 30 μm, 1 μm to 20 μm, 5 μm to 15 μm, or 5 μm to 10 μm. If the thickness of the porous substrate is within the above range, higher capacity may be achieved.

As such, the separator according to an embodiment includes polyethylene particles and inorganic particles in a predetermined weight ratio, and also includes a coating layer including first inorganic particles and plate-shaped Mg(OH)₂ second inorganic particles in a predetermined weight ratio. A separator with this combination has excellent adhesion to the electrode and also has excellent air permeability, allowing lithium movement to occur easily.

A separator for a lithium secondary battery according to an embodiment may be manufactured by various known methods. For example, in a separator for a lithium secondary battery, a coating layer forming composition is coated on one or both surfaces of a porous substrate and then dried to form a coating layer. Additionally, the composition for forming an adhesive layer may be coated on one surface of the coating layer and then dried to form an adhesive layer.

The composition for forming the coating layer may include polyethylene particles, first inorganic particles, and second inorganic particles, a binding binder, and a solvent. The solvent is not particularly limited as long as it may dissolve or disperse the polyethylene particles, the first inorganic particles, the second inorganic particles, and the binding binder. In an embodiment, the solvent may be an aqueous solvent including water, alcohol, or a combination thereof. The alcohol may be methyl alcohol, ethyl alcohol, propyl alcohol, or a combination thereof.

In the composition for forming a coating layer, a mixing ratio of the materials used may be adjusted appropriately, and there is no need to specifically limit it.

Additionally, the mixing process may be performed through a milling process such as a bead mill or ball mill, but is not limited thereto.

The coating may be performed by, for example, spin coating, dip coating, bar coating, die coating, slit coating, roll coating, inkjet printing, etc., but is not limited thereto.

The drying may be performed by, for example, natural drying, drying with warm air, hot air or low humidity air, vacuum drying, irradiation with far-infrared rays, electron beams, etc., but is not limited thereto. The drying process may be performed at a temperature of, for example, 25° C. to 120° C.

The composition for forming the coating layer may further include a curable binder.

The composition for forming an adhesive layer may include a binder, filler, and solvent. The solvent may be an aqueous solvent including water, alcohol, or a combination thereof. The alcohol may be methyl alcohol, ethyl alcohol, propyl alcohol, or a combination thereof.

Another embodiment provides a lithium secondary battery including a negative electrode, a positive electrode, a separator between the negative electrode and the positive electrode, and an electrolyte.

The separator is a separator according to an embodiment.

The negative electrode includes a current collector and a negative electrode active material layer formed on the current collector and including the negative electrode active material.

The negative electrode active material may be a material that reversibly intercalates/deintercalates lithium ions, a lithium metal, a lithium metal alloy, a material capable of doping/dedoping lithium, or a transition metal oxide.

Examples of the material that reversibly intercalates/deintercalates lithium ions include a carbon material, that is, a carbonaceous negative electrode active material commonly used in lithium secondary batteries. Representative examples of carbonaceous negative electrode active materials include crystalline carbon, amorphous carbon, or a combination thereof. Examples of the crystalline carbon may include graphite such as unspecified-shaped, plate-shaped, flake-shaped, spherical-shaped or fibrous-shaped natural graphite or artificial graphite, and examples of the amorphous carbon may include soft carbon or hard carbon, mesophase pitch carbonized product, sintered coke, etc.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, SiOₓ (0<x<2), a Si-Q alloy (wherein Q is an element selected from an alkali metal, an C alkaline-earth metal, a Group 13 element, a Group 14 element, a Group 15 element, a Group 16 element, a transition metal, a rare earth element, and a combination thereof, but not Si), a Si-carbon composite, Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, but not Sn), a Sn-carbon composite, and the like, and additionally, at least one of these may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

The titanium metal oxide may be lithium titanium oxide.

The negative electrode active material according to an embodiment may include a Si—C composite including a Si-based active material and a carbon-based active material.

The Si-based active material may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), or a combination thereof.

An average particle diameter of the Si-based active material may be 50 nm to 200 nm.

If the average particle diameter of the Si-based active material is within the above range, volume expansion that occurs during charging and discharging may be suppressed, and disconnection of the conductive path due to particle crushing during charging and discharging may be prevented.

The Si-based active material may be included in an amount of 1 wt % to 60 wt %, for example 3 wt % to 60 wt %, based on a total weight of the Si—C composite.

The negative electrode active material according to another embodiment may further include crystalline carbon along with the Si—C composite described above.

If the negative active material includes a Si—C composite and crystalline carbon, the Si—C composite and crystalline carbon may be included in the form of a mixture. In this case, the Si—C composite and crystalline carbon may be included in a weight ratio of 1:99 to 50:50. More specifically, the Si—C composite and crystalline carbon may be included in a weight ratio of 5:95 to 20:80.

The crystalline carbon may include, for example, graphite, and more specifically, may include natural graphite, artificial graphite, or a mixture thereof.

An average particle diameter of the crystalline carbon may be 5 μm to 30 μm.

In this specification, the average particle diameter may be the particle size (D50) at 50 volume % in the cumulative size-distribution curve. The average particle size (D50) may be measured by methods well known to those skilled in the art, for example, using a particle size analyzer, a transmission electron microscope photograph, or a scanning electron microscope. Alternatively, a dynamic light-scattering measurement device is used to perform a data analysis, and the number of particles is counted for each particle size range, and from this, the average particle diameter (D50) value may be easily obtained through a calculation.

The Si—C composite may further include a shell surrounding the surface of the Si—C composite, and the shell may include amorphous carbon. The thickness of the shell may be 5 nm to 100 nm.

The amorphous carbon may include soft carbon, hard carbon, mesophase pitch carbide, calcined coke, or mixtures thereof.

The amorphous carbon may be included in an amount of 1 part by weight to 50 parts by weight, for example, 5 parts by weight to 50 parts by weight, or 10 parts by weight to 50 parts by weight, based on 100 parts by weight of the carbon-based active material.

The negative electrode active material layer includes a negative electrode active material and a binder, and may optionally further include a conductive material.

In the negative electrode active material layer, the negative electrode active material may be included in an amount of 95 wt % to 99 wt % based on the total weight of the negative electrode active material layer. An amount of the binder in the negative electrode active material layer may be 1 wt % to 5 wt % based on a total weight of the negative electrode active material layer. In addition, if a conductive material is further included, 90 wt % to 98 wt % of the negative electrode active material, 1 wt % to 5 wt % of the binder, and 1 wt % to 5 wt % of the conductive material may be used.

The binder serves to well attach the negative electrode active material particles to each other and also to well attach the negative electrode active material to the current collector. The binder may be a non-water-soluble binder, a water-soluble binder, or a combination thereof.

The non-water-soluble binder may be an ethylenepropylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a styrene-butadiene rubber, an acrylated styrene-butadiene rubber, an acrylonitrile-butadiene rubber, an acrylic rubber, a butyl rubber, a fluoro rubber, an ethylene oxide-containing polymer, polyvinylpyrrolidone, polyepichlorohydrin, polyphosphazene, an ethylene propylenediene copolymer, polyvinyl pyridine, chlorosulfonatedpolyethylene, latex, a polyester resin, an acrylic resin, phenolic resin, an epoxy resin, polyvinyl alcohol, or a combination thereof.

If a water-soluble binder is used as the negative electrode binder, a cellulose compound capable of imparting viscosity may be further included as a thickener. The cellulose compound may include one or more types of carboxymethyl cellulose, hydroxypropylmethyl cellulose, methyl cellulose, or alkali metal salts thereof. The alkali metal may be Na, K, or Li. An amount of the thickener used may be 0.1 to 3 parts by weight based on 100 parts by weight of the negative electrode active material.

The conductive material is used to impart conductivity to the electrode, and any material may be used as long as it does not cause chemical change in the battery to be configured and is an electron conductive material. Examples of the conductive material may be a carbon-based material such as natural graphite, artificial graphite, carbon black, acetylene black, ketjen black, denka black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

The positive electrode includes a current collector and a positive electrode active material layer formed on the current collector and including a positive electrode active material. The positive electrode active material may include lithiated intercalation compounds that reversibly intercalate and deintercalate lithium ions, specifically one or more composite oxides of a metal selected from cobalt, manganese, nickel, and a combination thereof, and lithium. As a more specific example, a compound represented by any one of the following chemical formulas may be used. LiₐA_{1-b}X_{b}D₂ (0.90≤a≤1.8, 80≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0≤α≤2); LiₐNi_{1-b-c}CO_{b}X_{c}O_{2-α}T_{α} (0.90≤a≤1.8, 0≤b≤0.5, 0≤c≤0.5, 0≤α≤2); LiₐNi_{1-b-c}Co_{b}X_{c}O_{2-α}T₂ (0.90≤a≤1.8, 0≤b≤0.5, 0≤c≤0.5, 0≤α≤2); LiₐNi_{1-b-c}Mn_{b}X_{c}D_{α} (0.90≤a≤1.8, 0≤b≤0.5, 0≤c≤0.5, 0≤α≤2); LiₐNi_{1-b-c}Mn_{b}X_{c}O_{2-α}T_{α} (0.90≤a≤1.8, 0≤b≤0.5, 0≤c≤0.5, 0≤α≤2); LiₐNi_{1-b-c}Mn_{b}X_{c}O_{2-α}T₂ (0.90≤a≤1.8, 5≤b≤0.5, 0≤b≤0.5, 0≤α≤2); LiₐNi_{b}E_{c}G_{d}O₂ (0.90≤a≤1.8 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤11.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof: Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a C coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method (e.g., spray coating, dipping, etc.), but is not illustrated in more detail since it is well-known to those skilled in the related field.

In the positive electrode, an amount of the positive electrode active material may be 90 wt % to 98 wt % based on a total weight of the positive electrode active material layer.

In an embodiment, the positive electrode active material layer may further include a binder and a conductive material. At this time, each amount of the binder and the conductive material may each be 1 wt % to 5 wt % based on a total weight of the positive electrode active material layer.

The binder serves to well attach the positive electrode active material particles to each other and also to well attach the positive electrode active material to the current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be aluminum foil, nickel foil, or a combination thereof, but is not limited thereto.

The positive electrode active material layer and the negative electrode active material layer are formed by mixing an active material, a binder, and optionally a conductive material in a solvent to prepare an active material composition, and coating this active material composition on a current collector. This method of forming an active material layer is widely known in the art and thus detailed description will be omitted in this specification. The solvent includes N-methylpyrrolidone and the like, but is not limited thereto. Additionally, if an aqueous binder is used in the negative electrode active material layer, water may be used as a solvent used in preparing the negative electrode active material composition.

C The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butyl acetate, methyl propionate, ethyl propionate, propyl propionate, decanolide, mevalonolactone, caprolactone, and the like

The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and the like.

The non-aqueous organic solvents may be used alone or in combination with one or more. If the organic solvent is used in a mixture, the mixture ratio may be controlled in accordance with a desirable battery performance.

The carbonate-based solvent is prepared by mixing a cyclic carbonate and a chain carbonate. In this case, a mixture of cyclic carbonate and chain carbonate in a volume ratio of 1:1 to 1:9 may result in superior electrolyte solution performance.

If the non-aqueous organic solvent is mixed and used, a mixed solvent of a cyclic carbonate and a chain carbonate, a mixed solvent of a cyclic carbonate and a propionate-based solvent, or a mixed solvent of a cyclic carbonate, a chain carbonate, and a propionate-based solvent may be used. The propionate-based solvent may be methyl propionate, ethyl propionate, propyl propionate, or a combination thereof.

Herein, if the cyclic carbonate and the chain carbonate or the cyclic carbonate and the propionate-based solvent are mixed, they may be mixed in a volume ratio of 1:1 to 1:9 and thus performance of an electrolyte solution may be improved. In addition, if the cyclic carbonate, the chain carbonate, and the propionate-based solvent are mixed, they may be mixed in a volume ratio of 1:1:1 to 3:3:4. The mixing ratios of the solvents may be appropriately adjusted according to desirable properties.

The non-aqueous organic solvent of the present disclosure may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 1.

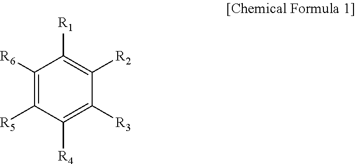

In Chemical Formula 1, R₁ to R₆ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include an additive of vinylene carbonate, or an ethylene carbonate-based compound of Chemical Formula 2 as a cycle-life enhancing additive.

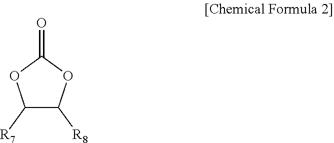

In Chemical Formula 2, R₇ and R₈ are the same or different, and are selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and R₇ and R₁ are not hydrogen.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. If using more of these cycle-life enhancing additives, the amount used may be adjusted appropriately.

The electrolyte may further include vinylethylene carbonate, propane sultone, succinonitrile, or a combination thereof, and the use amount may be adjusted appropriately.

The lithium salt dissolved in an organic solvent supplies a battery with lithium ions, basically operates the lithium secondary battery, and improves transportation of the lithium ions between positive and negative electrodes. Examples of the lithium salt may include one or two selected from LiPFe, LiBF₄, LiSbF₆, LiAsF₆, LiN(SO₂C₂F₅)₂, Li(CF₃SO₂)₂N, LiN(SO₃C₂F)₂, LiC₄F₉SO₃, LiClO₄, LiAlO₂, LiAlC₄, LiPO₂F₂, LiN(CₓF₂ₓ₋₁SO₂)(C_{y}F_{2y+1}SO₂) where x and y are natural numbers, for example integers of 1 to 20, lithium difluoro(bisoxalato) phosphate, LiCl, LiI, LiB(C₂O₄)₂ (lithium bis(oxalato) borate: LiBOB), and lithium difluoro(oxalato) borate (LiDFOB), as a supporting electrolytic salt. A concentration of the lithium salt may range from 0.1 M to 2.0 M. If the lithium salt is included at the above concentration range, an electrolyte may have excellent performance and lithium ion mobility due to optimal electrolyte conductivity and viscosity.

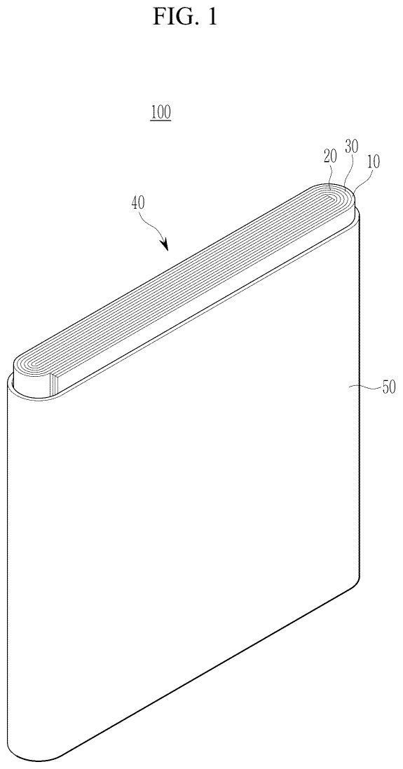

FIG. 1 shows an exploded perspective view of a lithium secondary battery according to an embodiment of the present invention. Although the lithium secondary battery according to an embodiment is described as an example of a prismatic shape, the present invention is not limited thereto and may be applied to batteries of various shapes, such as cylindrical and pouch types.

Referring to FIG. 1, a lithium secondary battery according to an embodiment may include an electrode assembly 40 manufactured by winding a separator 30 disposed between a positive electrode 10 and a negative electrode 20 and a case 50 housing the electrode assembly 40. An electrolyte solution (not shown) may be impregnated in the positive electrode 10, the F negative electrode 20 and the separator 30.

### MODE FOR PERFORMING THE INVENTION

This is only an example and the present invention is not limited to the following examples.

### Example 1

### 1. Preparation of Separator

A coating layer composition was prepared by adding polyethylene (PE) wax aqueous solution at a concentration of 40 wt % (an average size of polyethylene wax (D50): 1 μm, a melting temperature of the polyethylene wax: 110° C., a weight average molecular weight (Mw) of the polyethylene wax: 1500 g/mol, Tradename: PMD-01, Manufacturer: Nanjing Tianshi New Material Technologies Co., Ltd.), cubic boehmite with an average size (D50) of 650 nm (Anhui, available from ESTONE Technology), plate-shaped Mg(OH)₂ with an average size (D50) of 1.0 μm and a thickness of 0.25 μm, a polyvinyl alcohol binding binder, and a polyvinylidene fluoride-hexafluoropropylene (PVdF-HFP) copolymer (a weight average molecular weight: 450,000 g/mol) latex curable binder aqueous solution (a concentration of a curable binder: 8 wt %) to a water solvent and then, mixing them. Herein, a mixing ratio of polyethylene wax:boehrnite:plate-shaped Mg(OH)₂:bindingbinder:curable binder was a weight ratio of 56.7:378:34.02:4.4:1.1.

The coating layer composition was coated to be 3 μm thick on a one surface of a 5.5 μm-thick polyethylene porous substrate (air permeability: 113 sec/100 cc, puncture strength: 280 kgf, a melting temperature: 145° C., SK ie C technology Co., Ltd.) and then, dried at 70° C. for 10 minutes, forming a coating layer.

An adhesive layer composition at a concentration of 5 wt % (the concentration of the polyvinylidene fluoride homopolyrner and the acrylic copolymer: 5 wt %) was prepared by adding a mixture of a polyvinylidene fluoride homopolymer filler and an acrylic copolymer binder (in a weight ratio of 1:3) to a water solvent.

The adhesive layer composition was coated on both surfaces of the coating layer in a gravure coating method and then, dried to form an adhesive layer having a polymer loading amount of 0.7 g/m² (one surface) and a one surface thickness of 0.8 μm. As a result, the obtained separator had a five-layer structure of the substrate, the coating layers formed on both surfaces of the substrate, and the adhesive layers formed on the surface of one coating layer in contact with the substrate and on its opposite surface of the coating layer.

In the manufactured separator, a weight ratio of the curable binder, the binding binder, the plate-shaped Mg(OH)₂, the boehmite, and the porous polyethylene is shown in Table 1.

### 2. Fabrication of Half-Cell

A negative electrode was manufactured by mixing 94 wt % of artificial graphite, 3 wt % of Ketjen black, and 3 wt % of polyvinylidene fluoride in an N-methyl pyrrolidone solvent to prepare a negative electrode active material layer composition, coating the negative electrode active material layer composition on a copper current collector, and then, drying and pressurizing it.

The negative electrode, the prepared separator, and a lithium metal counter electrode were stacked, and an electrolyte was utilized therewith to manufacture a half-cell in a common method. The electrolyte was prepared by dissolving 1.5 M LiPF₆ in a mixed solvent of ethylene carbonate, ethylnethyl carbonate, and dimethyl carbonate (in a volume ratio of 2:1:7).

### Examples 2 to 6 and Comparative Examples 1 to 5

A separator and a half-cell were manufactured in the same manner as in Example 1 except that the separator was prepared by changing each amount of the curable binder, the binding binder, the plate-shaped Mg(OH)₂, the boehmite, and the polyethylene wax as shown Table 1.

Table 1 shows a weight ratio of the curable binder and the binding binder included in each coating layer composition and each weight of the plate-shaped Mg(OH)₂, the boehmite, and the polyethylene wax as wt % of each component based on 100 wt % of the total coating layer. In addition, a weight ratio thereof was calculated and then, shown in Table 2.

TABLE 1

| | Binder | | | | Polyethylene |
|---|---|---|---|---|---|
| Solid amount | curable | binding | Inorganic material | | particle |
| wt % | binder | binder | Mg(OH)₂ | boehmite | PMD-01 |
| Example 1 | 1.1 | 4.4 | 34.02 | 3.78 | 56.7 |
| Example 2 | 1.1 | 4.4 | 30.24 | 7.56 | 56.7 |
| Example 3 | 1.1 | 4.4 | 26.46 | 11.34 | 56.7 |
| Comparative | 1.1 | 4.4 | 22.68 | 15.12 | 56.7 |
| Example 5 | | | | | |
| Example 4 | 2.2 | 3.3 | 34.02 | 3.78 | 56.7 |
| Example 5 | 3.3 | 2.2 | 34.02 | 3.78 | 56.7 |
| Example 6 | 4.4 | 1.1 | 34.02 | 3.78 | 56.7 |
| Comparative | 1.1 | 4.4 | 37.8 | 0 | 56.7 |
| Example 1 | | | | | |
| Comparative | 1.1 | 4.4 | 0 | 37.8 | 56.7 |
| Example 2 | | | | | |
| Comparative | 1.1 | 4.4 | 0 | 0 | 94.5 |
| Example 3 | | | | | |
| Comparative | 1.1 | 4.4 | 75.6 | 18.9 | 0 |
| Example 4 | | | | | |

TABLE 2

| | | | | | Weight ratio |
|---|---|---|---|---|---|
| | | | | | of inorganic |
| | Binder | | | | material and |
| Solid weight | Curable | Binding | Inorganic material | | polyethylene |
| ratio | binder | binder | Mg(OH)₂ | Boehmite | particles |
| Example 1 | 2 | 8 | 9 | 1 | 4:6 |
| Example 2 | 2 | 8 | 8 | 2 | 4:6 |
| Example 3 | 2 | 8 | 7 | 3 | 4:6 |
| Comparative | 2 | 8 | 6 | 4 | 4:6 |
| Example 5 | | | | | |
| Example 4 | 4 | 6 | 9 | 1 | 4:6 |
| Example 5 | 4 | 6 | 9 | 1 | 4:6 |
| Example 6 | 6 | 4 | 9 | 1 | 4:6 |
| Example 7 | 8 | 2 | 9 | 1 | 4:6 |
| Comparative | 2 | 8 | 10 | 0 | 4:6 |
| Example 1 | | | | | |
| Comparative | 2 | 8 | 0 | 10 | 4:6 |
| Example 2 | | | | | |
| Comparative | 2 | 8 | — | — | — |
| Example 3 | | | | | |
| Comparative | 2 | 8 | — | — | — |
| Example 4 | | | | | |

### Experimental Example 1) Physical Property Evaluation

### 1) Air Permeability Evaluation

The separators according to Examples 1 to 7 and Comparative Examples 1 to 5 were measured with respect to air permeability, and the results are shown in Table 3. This air permeability experiment was performed by using an air permeability meter (TYPE EG01-55-1MR, ASAHI-SEICO Co., Ltd.) to measure time (seconds) that it took for 100 cc of air to pass each separator.

### 2) Evaluation of Binding Force

Each of the separators according to Examples 1 to 7 and Comparative Examples 1 to 5 with a porous substrate was cut into a width of 12 mm and a length of 50 mm, preparing samples. After attaching a tape attached to a slide glass to the adhesive layer side of the sample, the tape was peeled off from the adhesive layer by using a 180 [symbol] UTM tensile strength tester to measure a binding force. Herein, the peeling speed was set at 10 mm/min, and the binding force was three times measured to calculate an average force required to peel 400 mm off after starting the peeling. The results are shown in Table 3.

### 3) Evaluation of Resistance

After manufacturing a test cell by impregnating each of the separators according to Examples 1 to 7 and Comparative Examples 1 to 5 in an electrolyte prepared by dissolving 1.5 M LiPF₆ in a mixed solvent of ethylene carbonate, ethylmethyl carbonate, and dimethyl carbonate (in a volume ratio of 2/1/7), inserting it into an aluminum foil electrode with a lead tab, and sealing it with an aluminum pack, the resistance (Ω) of the test cell was measured at 20° C. in an alternating current (AC) impedance method (at a measurement frequency of 100 kHz), and then, the results are shown in Table 3 as the film resistance.

4) Evaluation of Air Permeability after Heat Exposure

Each of the separators according to Examples 1 to 7 and Comparative Examples 1 to 5 was maintained at 130° C. for 1 hour and then, measured with respect to air permeability in the same method as the method for measuring air permeability above. The results are shown in Table 3.

### 5) Evaluation of Heat Exposure

Each of the half-cells according to Examples 1 to 7 and Comparative Examples 1 to 5 was fully charged (SOC100, a full-charge state, a charge state to 100% charge capacity based on 100% of total battery charge capacity) and C then, allowed to stand at 134° C. for 1 hour to examine battery conditions, which are shown as heat exposure results in Table 3. In Table 3, OK means ‘not ignited’, and NG means ‘ignited’.

### 6) Evaluation of Penetration

A penetration experiment was performed on the half-cells according to Examples 1 to 7 and Comparative Examples 1 to 5, and the results are shown in Table 3.

The penetration experiment was performed by charging each half-cell at 0.5 C to 4.4 V for 3 hours, putting a pause for about 10 minutes (up to 72 hours), and then, completely penetrating the center of the cell with a pin having a diameter of 5 mm at 50 mm/sec. In Table 3, OK means ‘not ignited’, and NG means ‘ignited or exploded.’

TABLE 3

| | | | | Safety Evaluation | | |
|---|---|---|---|---|---|---|
| | Properties | | | After being left at | | |
| | | Substrate | | 130° C. for 1 | | |
| | Air | binding | | hour, air | Heat | |
| | permeability | force | Resistance | permeability | exposure | |
| | (sec/100 cc) | (gf/mm) | (Ω) | (sec/100 cc) | (134° C.) | Penetration |
| Example 1 | 184 | 8.54 | 0.284 | 26542 | OK | OK |
| | | | | | | (fine spark) |
| Example 2 | 179 | 8.12 | 0.275 | 25882 | OK | OK |
| | | | | | | (fine spark) |
| Example 3 | 172 | 7.42 | 0.262 | 25554 | OK | OK |
| | | | | | | (fine spark) |
| Comparative | 166 | 6.97 | 0.245 | 24987 | OK | NG |
| Example 5 | | | | | | (ignition) |
| Example 4 | 180 | 4.26 | 0.278 | 25592 | OK | OK |
| | | | | | | (fine spark) |
| Example 5 | 174 | 3.57 | 0.257 | 25484 | OK | OK |
| | | | | | | (fine spark) |
| Example 6 | 169 | 1.94 | 0.247 | 24911 | NG | OK |
| | | | | | | (fine spark) |
| Comparative | 224 | 9.16 | 0.368 | 27885 | OK | OK |
| Example 1 | | | | | | (fine spark) |
| Comparative | 158 | 8.94 | 0.244 | 24125 | OK | NG |
| Example 2 | | | | | | (explosion) |
| Comparative | coating not | | | | | |
| Example 3 | possible | | | | | |
| Comparative | 286 | 11.46 | 0.396 | 291 | OK | NG |
| Example 4 | | | | | | (ignition) |

As shown in Table 3, Examples 1 to 6, in which first inorganic particles and second inorganic particles were included in each coating layer within an appropriate range, maintained room temperature air permeability at an appropriate level and also, if allowed to stand at a high temperature, exhibited significantly increased air permeability, which confirmed very excellent high temperature safety.

In addition, Examples 1 to 6 exhibited appropriate binding force and resistance and also, very excellent safety as results of the heat exposure and penetration experiments.

On the other hand, Comparative Example 1, which included the second inorganic particles alone, exhibited too high resistance, and Comparative Example 2, which included the first inorganic particles alone, exhibited too low air permeability and explosion in the penetration experiment.

In addition, because in Comparative Example 3 not using both first and second inorganic particles, a coating layer was impossible to form, no physical property experiments were performed.

Furthermore, Comparative Example 4, of which a coating layer included no polyethylene particles, exhibited high resistance and explosion in the penetration experiment.

In addition, Comparative Example 5, of which a coating layer included both the first inorganic particles and the second inorganic particles, wherein the second inorganic particles of plate-shaped Mg(OH)₂ were used in a smaller amount than the first inorganic particles, exhibited explosion in the penetration experiment, which confirmed that safety was significantly deteriorated.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims. Therefore, the aforementioned embodiments should be understood to be exemplary but not limiting the present invention in any way.

1. A separator for a lithium secondary battery, the separator comprising:
a porous substrate; and
a coating layer located on at least one surface of the porous substrate and including polyethylene particles, inorganic particles, and a binding binder,
wherein the inorganic particles are a mixture of first inorganic particles and second inorganic particles,
the second inorganic particles are plate-shaped Mg(OH)₂,
a mixing ratio of the polyethylene particles and the inorganic particles is a weight ratio of 5:5 to 8:2, and
an amount of the second first-inorganic particles is greater than an amount of the first inorganic particles.

2. The separator for a lithium secondary battery as claimed in claim 1, wherein a mixing ratio of the first inorganic particles and the second inorganic particles is a weight ratio of 1:9 to 3:7.

3. The separator for a lithium secondary battery as claimed in claim 1, wherein the first inorganic particles include Al₂O₃, SiO₂, TiO₂, SnO₂, CeO₂, MgO, NiO, CaO, GaO, ZnO, ZrO₂, Y₂O₃, SrTiO₃, BaTiO₃, boehmite, or a combination thereof.

4. The separator for a lithium secondary battery as claimed in claim 1, wherein an amount of the binding binder is greater than or equal to 1 wt % and less than 6.5 wt % based on 100 wt % of the coating layer.

5. The separator for a lithium secondary battery as claimed in claim 1, wherein the coating layer further includes a curable binder.

6. The separator for a lithium secondary battery as claimed in claim 1, wherein the coating layer further includes a curable binder, and
a total amount of the binding binder and the curable binder is greater than or equal to 5 wt % based on 100 wt % of the coating layer.

7. The separator for a lithium secondary battery as claimed in claim 1, wherein the coating layer further includes a curable binder, and
a mixing ratio of the binder and the curable binder is a weight ratio of 1:9 to 9:1.

8. The separator for a lithium secondary battery as claimed in claim 1, wherein the separator further includes an adhesive layer on one surface of the coating layer.

9. The separator for a lithium secondary battery as claimed in claim 8, wherein the adhesive layer includes a binder and a filler.

10. The separator for a lithium secondary battery as claimed in claim 9, wherein the binder includes (meth)acrylic acid, (meth)acrylate, (meth)acrylonitrile, (meth)acrylamidosulfonic acid, a (meth)acrylamidosulfonate salt, styrene, ethylhexyl acrylate, a combination thereof, or a copolymer thereof.

11. The separator for a lithium secondary battery as claimed in claim 9, wherein the filler includes polyvinylidene fluoride, polyvinylidene fluoride-hexafluoropropylene copolymer, polytetrafluoroethylene, or a combination thereof.

12. The separator for a lithium secondary battery as claimed in claim 1, wherein an amount of the second inorganic particles is 20 wt % to 50 wt % based on 100 wt % of the coating layer.

13. The separator for a lithium secondary battery as claimed in claim 1, wherein an amount of the inorganic particles is 25 wt % to 55 wt % based on 100 wt % of the coating layer.

14. The separator for a lithium secondary battery as claimed in claim 1, wherein the binding binder is an aqueous binder.

15. A lithium secondary battery, comprising:
a negative electrode including a negative electrode active material;
a positive electrode including a positive electrode active material;
the separator as claimed in claim 1 between the negative electrode and the positive electrode; and
a non-aqueous electrolyte.
